(19) United States
(12) Patent Application Publication
(10) Pub. No.: US 2008/0141898 A1
(43) Pub. Date: Jun. 19, 2008

(54) Mopping grade asphalts

(76) Inventor: John R. Fields, Sumner, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/960,779

(22) Filed: Oct. 7, 2004

(51) Int. Cl. C08L 95/00

(52) U.S. Cl. 106/278; 106/281.1; 106/282

(57) ABSTRACT

Improved mopping grade asphalt compositions and methods of preparing them. Methods according to the invention include mixing asphalt with a gelling agent such as attapulgite or other clay and with thixotropic agents such as synthetic or organic fillers, and optionally with one or more of ether amine or other surfactants. Thixotropic agents may for example include cellulose fibers, polyolefin fibers, and mineral wool. The asphalt compositions are mixed in a shearing mixer at a temperature high enough to provide substantially uniform dispersion of each of the mixed ingredients in the completed composition. Inventive compositions provide viscosities suitable for application at 200-350 degrees Fahrenheit or lower, excellent adhesion, and superior sag resistance.

### BACKGROUND OF THE INVENTION

The invention relates to sealing and waterproofing products, and in particular to compositions for and methods of making improved mopping grade asphalt compositions.

Asphalt compositions have been used as sealants and paving compounds for thousands of years, on roofs, roads, and in many other applications. Originally asphalts were taken straight from bituminous deposits in the earth and applied directly. More recently they have been derived from the distillation of petroleum products, typically being defined as the end residue of the distillation process.

For many years, asphalts, including those derived from petroleum, were used in the rough forms in which they were found or distilled, without additives. As a result of efforts to address the non-uniform compositions and other undesirable properties such rough asphalts typically exhibit, however, additives such as lube oil stock began to be employed. It is now typical for rough asphalts to be blended with various additives into relatively uniform asphalts which may either be employed directly or used as base stock for more specialized or improved asphalt forms. Most typically, the resultant asphalts are further modified before use.

For example, it is very common to modify asphalts used for any purpose to increase their softening points. Unmodified asphalts typically exhibit softening points in the range of 85-90 degrees Fahrenheit (F.). Given that surface temperatures on an asphalt roof or roadway may, under a summer sun, climb well above 200 degrees F., it may be seen that in many applications softening points in the region of 90 degrees F. are unsuitable. A number of ways of increasing the softening point of asphalt compositions and improving other undesirable qualities are known.

It has been found to be very difficult, however, to increase the softening point of asphalts while retaining or providing other desirable qualities. One of the most common means of raising the softening point of asphalts is by oxidation. In a typical oxidation process, asphalt is placed in a large holding tank, or air still, and heated to approximately 500 degrees F. at atmospheric pressure. Air is introduced at the bottom of the tank and allowed to percolate up toward the top of the asphalt, creating an exothermic reaction which lengthens molecular bonds between asphalt particles and thus has the effect of raising the softening point of the asphalt. The degree to which the softening point is raised is a function of the amount of oxidation to which the asphalt is subjected.

The ASTM has published, in its D 312 Standard Specification for Asphalt Used in Roofing, standards for the oxidization of asphalts, including a specification of physical properties of the asphalts following oxidization. ASTM standards from D 312 are shown in Table 1. Type IV is the most highly oxidized of the ASTM asphalts, Type I the least.

TABLE 1

| | Type I | | Type II | | Type III | | Type IV | |
|---|---|---|---|---|---|---|---|---|
| Property | min | max | min | max | min | max | min | max |

| | | | | |
|---|---|---|---|---|
| Softening | 135-151 | 158-176 | 185-205 | 210-225 |
| point (deg. F.) | | | | |
| Flash point | 500 | 500 | 500 | 500 |
| (deg. F.) | | | | |
| Penetration | 18-60 | 18-40 | 15-35 | 12-25 |
| (@ 77 deg. F.) | | | | |
| Ductility | 10.0 | 3.0 | 2.5 | 1.5 |
| (cm. @77 | | | | |
| deg. F.) | | | | |
| Solubility | 99 | 99 | 99 | 99 |
| in trichloro- | | | | |
| ethylene (%) | | | | |

As shown in Table 1, however, the oxidation of asphalt, without further modifications, can introduce undesirable side effects. For example, two such undesirable side effects of the oxidation process are reductions in the ductility and the penetration values of the oxidized asphalt. Reductions in ductility and penetration values result in decreased resistance to thermal fatigue cycles, increased brittleness, and accelerated material breakdown. Indeed, the process of oxidizing asphalt actually degrades the asphalt's waterproofing and weathering ability. Oxidation causes many of the desirable lighter oils found in the asphalt (the “light end” oils) to be burned off. These light-end oils would otherwise provide properties that keep the asphalt elastic and waterproof, and provide superior roofing and waterproofing systems. To restore these properties in oxidized asphalts, a number of additives have been found to be useful, though none has been ideal and many have introduced other undesirable qualities; and all require added expense and processing to the creation of the asphalt compositions. The additives to be used have depended upon the application to which the asphalt is to be put, and the manner in which the asphalt is to be applied.

One form in which asphalts have been applied to roofs and other surfaces is that known as mopping grade asphalts. Mopping grade asphalts have been known and used for more than 100 years. Mopping grade asphalts are typically heated at the installation site (or heated off-site and transported to the worksite) to a point at which their viscosity is sufficiently low as to allow them to be spread directly on a roof or other substrate, using a mop, squeegee, or other device. Heretofore, it has been necessary to heat mopping grade compositions to temperatures of 500 degrees F. or more for application.

The heating of such asphalts to such high temperatures for transportation and application is expensive and extravagantly wasteful of energy resources, produces prodigious amounts of pollutants, and is physically dangerous to those who handle the asphalts or travel the highways and roadways with the heated compositions. The handling of asphalts at such temperatures exacerbates, for example, the many occurrences of accidental burn injuries among workers each year. Even when safely handled, the heating of such compositions results in the release of copious amounts of fumes, odors, and other emissions at thousands of worksites each day.

To avoid the necessity of heating asphalts to such high temperatures for application, several solutions have been offered. For example, asphalt compositions comprising large amounts of mineral spirit or other cutback chemicals have been provided; and aqueous emulsions have been developed. Both cutback and emulsion compositions may be applied at ambient temperature, without heating, but neither provides the high quality adhesion, sealing and waterproofing qualities of hot mopping asphalts.

The oxidation process, too, is expensive, harmful to the environment, and potentially dangerous to those conducting the process. Oxidation processes require heating to temperatures of 500 degrees F. for periods of five to eight hours, or more; and produce emissions that must be incinerated at approximately 1400 degrees F. in order to meet EPA and other air quality standards. Air still emissions are closely regulated by environmental agencies, due to the high volume and toxicity of the emissions.

Oxidation also consumes large quantities of natural gas and electricity. It is estimated that at today's energy costs, the value of natural gas and electricity consumed each year for oxidizing asphalt in the United States runs into the millions of dollars.

There exists a need for mopping grade asphalts which do not require oxidation or dangerous and expensive heating for transportation and application, and which provide adequate and superior waterproofing, sealing, and weathering qualities, without the use of cutback or emulsifying agents, while providing superior sag resistance and adhesion.

### SUMMARY OF THE INVENTION

The invention provides compositions for and methods of making improved mopping grade asphalts. Asphalts according to the invention exhibit superior adhesion and sag resistance, and improved ductility and other qualities while providing superior waterproofing, sealing, and weathering qualities, without requirement for oxidation or heating to extremely high temperatures prior to application. Through the addition of carefully selected combinations of gelling agents, surfactants, stabilizers, thixotropic agents such as fibers, and other components in various quantities to an unoxidized asphalt, and carefully controlled application of blending processes, an asphalt having a number of superior qualities is provided. For example, asphalts are provided which may be heated at the worksite to, and applied at, temperatures of 250 to 450 degrees F. In some cases, asphalts are provided which may be successfully applied at temperatures in the range of only about 175 degrees F. These temperatures represent considerable improvements over the 500 degree F. temperatures commonly required for working with and applying prior art mopping grade asphalts.

Thus the invention provides, among other advantages, reduced monetary and energy costs, and reduced risks to the environment and to persons and other creatures in the production, handling, and application of superior mopping grade asphalts. Annual expenditures for fuels, additives, environmental cleanup and protection, and for the protection and cure of injured workers in the production of such asphalts can be significantly reduced, while providing greatly improved asphalt compositions.

Among the challenges encountered and overcome in providing such asphalts are the need to find additives that are not destroyed at the temperatures required for mixing and applying the asphalt; the need to identify gelling agents that keep the additives in suspension at mixing and application temperatures; suitable combinations of additives to provide acceptable sag resistance, ductility, and other properties; the need to create an asphalt having adequate application viscosities at greatly reduced temperatures; and the need to provide convenient and effective packaging for such asphalts. Compositions and methods according to the invention were developed during a painstaking and exacting course of experimentation, in which combinations exhibiting a number of unexpected qualities were produced.

Such embodiments of the invention include mopping grade asphalt compositions and methods of preparing them. Methods according to the invention include mixing unoxidized asphalt with one or more gelling agents, such as attapulgite and/or other clays, and optionally with limestone flour or other organic or synthetic fillers, which may serve as stabilizers in keeping other additives satisfactorily dispersed throughout the finished compositions; one or more surfactants, such as acetates or other ether amines; and with a variety of fillers and thixotropic agents such as cellulose or other fibers, polyolefin fibers such as polypropylene, nylon, acrylic, and polyester, and mineral wool, which may help control sag resistance and other properties; in a shearing mixer at a temperature high enough to provide substantially uniform dispersion of each of the mixed ingredients in the completed composition. Suitable temperatures are found to be within the 175-450 degree F. range, and in some circumstances advantageously about 300 degrees F.

Embodiments of the invention further include compositions made by such methods.

In some embodiments, compositions according to the invention comprise about 0.20 to about 0.99 parts by weight asphalt; about 0.001 to about 0.10 parts by weight attapulgite or other clay gelling agent; zero to about 0.10 parts by weight surfactant; zero to about 0.85 parts by weight of limestone flour; zero to about 0.10 parts by weight cellulose fiber; zero to about 0.10 parts by weight polyolefin fibers such as polypropylene; and zero to about 0.30 parts by weight mineral wool. Various combinations of such components will provide satisfactory compositions, so long as the compositions serve the purposes described herein.

Such compositions may be blended by introducing a portion, such as for example about one-half, of the asphalt at about 250-310 degrees F. into a shearing mixer, with the gelling clay and optionally a surfactant, and mixing to form a gel; blending the asphaltic gel with thixotropic agents such as any cellulose fiber and mineral wool to achieve a substantially uniform dispersion; blending in a separate mixer the remainder of the asphalt at about 350-400 degrees F. with the limestone or other mineral flour; and then mixing the contents of the two mixers. Mixing until a substantially uniform dispersion has been achieved produces a stable mopping grade asphalt composition that may be applied at greatly reduced temperatures, relative to prior art mopping grade asphalts, and which exhibits superior sag resistance, adhesion, and sealing and waterproofing qualities.

Mixing the composition initially in separate batches, at optionally different temperatures, as described, can be used as a way of preventing or controlling degradation of additives such as breakdown of any cellulose or surfactants, and to produce a finished composition at a temperature at which the composition may be packaged in consumable sheet material as described herein.

In some preferred embodiments, compositions according to the invention comprise about 0.42 to about 0.48 parts by weight asphalt; about 0.005 to about 0.06 parts by weight attapulgite clay; zero to about 0.03 parts by weight of ether amine (e.g. isodecyloxypropylamine acetate) surfactant; about 0.40 to about 0.60 parts by weight of limestone flour comprising at least 80 per cent by weight of at least one of calcium carbonate and magnesium carbonate; zero to about 0.02 parts by weight cellulose fiber; zero to about 0.02 parts by weight polypropylene fibers; and zero to about 0.10 parts by weight of mineral wool.

It should be noted that exact formulations of compositions according to the invention may depend upon the characteristics of the ashpalt used. The characteristics of asphalts sometimes vary, depending upon, for example, their source. Thus it may be necessary, for example, to vary the amounts of thixotropic and gelling agents to ensure that suitable sag resistance and application viscosities are provided in the finished composition.

In some embodiments, the invention provides asphalt compositions packaged in consumable sheet material. For example, asphalt compositions according to the invention may be divided into conveniently handled portions of, for example, approximately 30 pounds, and wrapped in plastic sheet having a melting point of about 250 to about 300 degrees F. Such asphalts may be readied for application by placing one or more wrapped packages of the asphalt in a suitable heating vessel, such as a kettle; heating the packaged asphalt at the application site to a temperature above the melting point of the plastic; and mixing the asphalt and melted plastic container. Preferably, plastics and other sheet materials used for such consumable packaging add neutral or preferably beneficial qualities to the heated asphalt compositions.

The wrapping of mopping grade asphalts in consumable materials represents a significant improvement over prior art practices. Traditionally, for more than a century, mopping grade asphalts have been packaged in 100-pound portions, in cardboard cylinders capped at either end with metal lids. The 100-pound weights are, by modern standards, unacceptably large; back injuries are common to roofing workers subjected to handling such large loads. Moreover, to remove asphalt from such packaging, a worker must rip the packing cylinder apart and pry the metal lids from either end. The non-consumable packaging must then be collected and disposed of. This results in the expenditure of significant amounts of worker time and disposal resources, such as waste container and landfill capacity. In addition, the unpackaged 100-pound asphalt cylinder, which is about 2 feet long and 1 foot in diameter, must be chopped into smaller pieces in order to fit into the heating vessel and provide sufficient exposed surface area for more efficient melting. This chopping is typically accomplished with an axe, thus resulting in further expenditure of worker time and further exposure of the worker to injuries. It also leads to some loss of smaller chips of unmelted asphalt, with resultant waste and environmental damage.

Packaging asphalts according to the invention in consumable materials, in smaller, more readily-handled portions of size suitable for efficient melting (e.g., of approximately 30 pounds) reduces handling injuries, waste disposal problems, and environmental damage. Moreover, suitable materials, such as polypropylene, can, when used as consumable packaging, contribute beneficial characteristics to melted asphalt.

Asphalts according to the invention may also comprise other additives for providing or improving various qualities of the asphalts. For example, asphalts according to the invention may comprise fire retardants such as aluminum trihydrate, colorings and other components such as latex and/or odor-masking compositions, such as high High Temperature Fragrance product No. 83846 from Stanly S. Schoenmann, Inc., of Clark, N.J.

Additional aspects of the present invention will be apparent in view of the description which follows.

### BRIEF DESCRIPTION OF THE FIGURES

Aspects of the invention are illustrated in the figures of the accompanying drawing, which is meant to be exemplary and not limiting, and in which like references are intended to refer to like or corresponding parts.

FIG. 1 is a schematic diagram of a shearing mixer suitable for use in preparing mopping grade asphalt compositions according to the invention.

### DETAILED DESCRIPTION

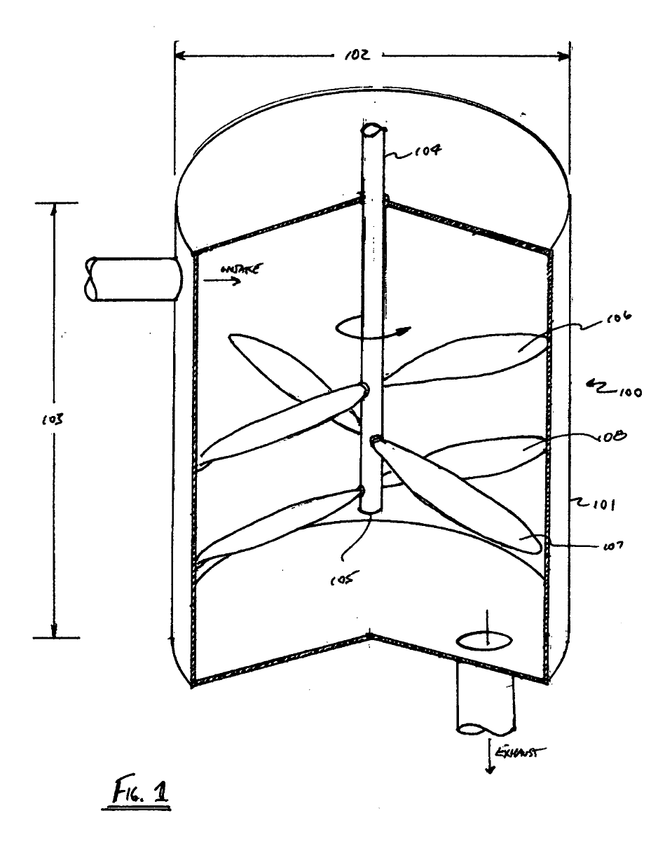

FIG. 1 is a schematic diagram of a shearing mixer suitable for use in preparing mopping grade asphalt compositions according to the invention. It has been found that, in preparing compositions according to the invention, it is possible to achieve suitable dispersion, or mixing, of the asphalt with the gelling agents, surfactants, and/or other additives, using one or more shearing mixers 100 capable of approximately one hundred revolutions per minute (RPM). Such a mixer may be fabricated, for example, from a vertical cylindrical tank 101 of approximately 1000 gallons capacity, having a diameter 102 of approximately eight feet and a height 103 of approximately 9 feet, with a power driven shaft 104 descending from the top of the tank to a point 105 just above the bottom of the tank. It has been found that an electric motor of approximately 20 horsepower output with a gear box producing approximately 100 RPM on the power shaft will serve. Attached to the shaft may be disposed several sets of shearing blades, spaced at approximately equal intervals along the shaft. A shaft comprising three sets of such blades, each set consisting of two blades disposed horizontally on opposite sides of the shaft, with the top set of blades 106 disposed about four feet below the top of the tank and the and lowest set 107 disposed about three feet from the bottom of the tank has produced satisfactory results.

Using a mixer of these dimensions permits the preparation of about 10,000 pounds of mopping grade asphalt composition according to the invention.

It has been found that introducing asphalt to the mixer in the amounts and at the temperatures described herein, and adding the various additives from the top of the tank at ambient temperatures while the mixer is operating, will produce satisfactory dispersion of all components. Mixing times of approximately 15-30 minutes have produced substantially homogenous or uniform dispersions. A substantially homogeneous dispersion in this context means a dispersion providing a substantially uniform color and blending of the asphalt and any additives, sufficiently blended to serve the purposes described herein.

It has been found, by experimentation, that heating the asphalt to approximately 250-400 degrees F. in order to mix the additional components, described herein, provides, upon mixing, a very high-quality asphalt composition. However, as will be appreciated by those of ordinary skill in the relevant arts, heating the asphalt to any temperature significantly lower than the 500 degrees F. commonly required for oxidizing asphalt and preparing mopping grade asphalts for application will lead to improvements in the cost of preparing the compositions, reduced energy use and pollutant creation, and reduced hazards for workers and those traveling in proximity to hot product. Thus, asphalts according to the invention may be prepared at any temperatures significantly lower than about 500 degrees F. For example, the invention may be advantageously practiced by heating the asphalt to about 450 degrees F., or lower. Particular efficiencies and quality in the resulting compositions have been realized by heating the asphalt to about 250-310 degrees F., as herein described.

Mixing methods of the type described, using equipment of the type described, represent substantial improvements over prior art processes for preparing mopping grade asphalts and other asphalts, many of which have required mixing using specialized, and generally expensive and relatively inefficient, high-speed mixing or grinding equipment, such as Siefer Trigonal wet mills or Dorr-Oliver Bitumen Homogenizers, each of which operates at 3000 RPM or more, Charlotte Colloid Mills (3600 RPM), or Myers High Shear Mixers (2000 RPM). The costs of obtaining and operating such equipment are in general much higher than those associated with mixers and processes according to the invention.

It has been found to be advantageous in some circumstances to package the finished asphalt composition in a wrapping of consumable sheet material, such as a plastic sheet (e.g., polypropylene) having a melting point of between 250 and 300 degrees F. A number of molds having suitable shapes, for example substantially rectangular molds about 18 inches by 14 inches by 6 inches may be used, and lined with suitable sheet material. The molds may then be placed on a conveyor or other device and passed beneath a filling spigot, and filled with prepared mopping grade asphalt composition, the asphalt composition being preferably at a temperature sufficiently below the melting point of the consumable sheet to prevent the sheet from melting and mixing with the asphalt composition. Thereafter the sheet material may be folded over the top surface of the asphalt to seal the package, and the package may be cooled by water, forced air, or other medium, stored, and shipped for use.

For example, Fields White T5 Poly sheet, available from Shields Bag & Printing, of Yakima, Wash., has been found to serve satisfactorily as a consumable sheet material. White T5 Poly has a melting point of about 250-300 degrees F. To be packaged using such materials, ashpalt compositions according to the invention are cooled to about 230 degrees F., at which they retain acceptably low viscosities, and are poured into a mold lined with the White T5 Poly. The packages are closed and cooled using water or forced air and prepared for shipping or further handling.

By careful and controlled experimentation using equipment of the type described herein, the compositions described in the following examples have been found to serve well as mopping grade asphalts. Each of the asphalts comprises a viscosity, at approximately 250-300 degrees F. (and sometimes as low as 200 degrees F.), low enough to allow them to be applied using standard hot mopping equipment, while retaining sufficient sag resistance to serve as superior exterior waterproofing and sealing systems on roofs and other substrates.

Prior art mopping asphalts and compositions according to the invention were tested by spreading on a wood substrate at a 2:12 pitch (approximately 9.5 degrees from the horizontal; the maximum incline for which mopping grade asphalts are generally used without back-nailing) and baking in an oven for several hours. It was found that prior-art standard mopping grade asphalts, oxidized to ASTM D312 Type IV, failed at approximately 225 degrees F. Asphalts according to the invention, prepared according to the example compositions given below, showed no sag to 295 degrees F., at which point the wooden substrates combusted. Thus, sag resistance in compositions according to the example far exceeded those of the best prior art asphalts.

It has also been found that asphalts according to the invention provide superior adhesive qualities. This provides an advantage over, for example, ambient-applied asphalts such as mineral spirit cutback asphalts and aqueous emulsions. Emulsion asphalts, for example, are not generally regarded as satisfactory for adhesive purposes, and are typically used only for top coating. Asphalts according to the invention provide adhesiveness comparable to prior art hot mopping grade asphalts, without the high-temperature heating requirements needed for use thereof.

It has been found that the following specific components may be used to make satisfactory mopping grade asphalt compositions according to the invention, particularly as described in the following specific examples:

For asphalt, the unoxidized asphalt available from Imperial Oil of Edmonton, Alberta.

As a gelling agent, Min-U-Gel G35®, available from Floridin, a division of ITC Industrials, Quincy, Florida. Min-U-Gel® G35 is an attapulgite clay, including specifically an hydrous magnesium aluminum silicate. A typical chemical analysis includes 66.1 parts by weight (“pbw”) SiO₂, 11.71 pbw Al₂O₃, 4.02 pbw Fe₂O₃, 0.55 pbw TiO₂, 0.99 pbw P₂O₅, 2.92 pbw CaO, 9.70 pbw MgO, 1.07 pbw K₂O, 2.57 pbw CO₂, 0.25 pbw SO₄, and a specific gravity of approximately 2.4 grams per milliliter.

As a surfactant, PA 14, available from Tomah Products, Inc., of Milton, Wis. PA 14 is a 100% cationic amine salt of the primary ether amine family, specifically isodecyloxypropylamine acetate.

As a filler and stabilizer, 40-mesh limestone flour available from Hemphill Brothers, Seattle, Wash. This includes ground limestone, or calcitic lime. In general, any ground stone (i.e., flour) comprising about 80 per cent or more by weight of at least one of calcium carbonate and magnesium carbonate will serve.

As a filler and thixotropic agent, cellulose fiber such as Interfibe 230, a coarse-milled cellulose fiber having an average fiber diameter of approximately 40 microns, available from Interfibe Corporation of Portage, Mich.

As a filler and thixotropic agent, polyolefin fibers, including Short Stuff® fibrillated polypropylene fibers, product no. SS-03, formula —{CH₂—CH(CH₃)}-n, available from MiniFibers, Inc., Johnson City, Tenn.

As a filler and thixotropic agent, MG 615-Roxul 1000 rock or mineral wool from AKZO Nobel Surface Company, Strafford, Conn. In general, it is expected that any glass made from molten slag, rock, glass or combination of, these ingredients, of characteristics otherwise similar to MG 615, will serve.

### EXAMPLE 1

| | | |
|---|---|---|
| Asphalt | 0.4715 pbw | 943 lbs./ton |
| G35 MinUGel ® | 0.0100 pbw | 20 lbs./ton |
| PA 14 surfactant | 0.0065 pbw | 13 lbs./ton |
| 230 Cellulose | 0.0120 pbw | 24 lbs./ton |
| Limestone flour | 0.5000 pbw | 1000 lbs./ton |

### EXAMPLE 2

| | | |
|---|---|---|
| Asphalt | 0.4735 pbw | 947 lbs./ton |
| G35 MinUGel ® | 0.0100 pbw | 20 lbs./ton |
| PA 14 surfactant | 0.0065 pbw | 13 lbs./ton |
| SS Polypropylene | 0.0100 pbw | 20 lbs./ton |
| Limestone flour | 0.5000 pbw | 1000 lbs./ton |

### EXAMPLE 3

| | | |
|---|---|---|
| Asphalt | 0.4335 pbw | 867 lbs./ton |
| G35 MinUGel ® | 0.0100 pbw | 20 lbs./ton |
| PA 14 surfactant | 0.0065 pbw | 13 lbs./ton |
| 615 Rock Wool | 0.0500 pbw | 100 lbs./ton |
| Limestone flour | 0.5000 pbw | 1000 lbs./ton |

### EXAMPLE 4

| | | |
|---|---|---|
| Asphalt | 0.4710 pbw | 942 lbs./ton |
| G35 MinUGel ® | 0.0100 pbw | 20 lbs./ton |
| PA 14 surfactant | 0.0065 pbw | 13 lbs./ton |
| 230 Cellulose | 0.0100 pbw | 20 lbs./ton |
| SS Polypropylene | 0.0025 pbw | 5 lbs./ton |
| Limestone flour | 0.5000 pbw | 1000 lbs./ton |

### EXAMPLE 5

| | | |
|---|---|---|
| Asphalt | 0.4750 pbw | 950 lbs./ton |
| G35 MinUGel ® | 0.0100 pbw | 20 lbs./ton |
| PA 14 surfactant | 0.0065 pbw | 13 lbs./ton |
| 230 Cellulose | 0.0050 pbw | 10 lbs./ton |
| 615 Rock Wool | 0.0035 pbw | 7 lbs./ton |
| Limestone flour | 0.5000 pbw | 1000 lbs./ton |

### EXAMPLE 6

| | | |
|---|---|---|
| Asphalt | 0.4755 pbw | 951 lbs./ton |
| G35 MinUGel ® | 0.0100 pbw | 20 lbs./ton |
| PA 14 surfactant | 0.0065 pbw | 13 lbs./ton |
| SS Polypropylene | 0.0045 pbw | 9 lbs./ton |
| 615 Rock Wool | 0.0035 pbw | 7 lbs./ton |
| Limestone flour | 0.5000 pbw | 1000 lbs./ton |

### EXAMPLE 7

| | | |
|---|---|---|
| Asphalt | 0.4730 pbw | 946 lbs./ton |
| G35 MinUGel ® | 0.0100 pbw | 20 lbs./ton |
| PA 14 surfactant | 0.0065 pbw | 13 lbs./ton |
| 230 Cellulose | 0.0045 pbw | 9 lbs./ton |
| SS Polypropylene | 0.0025 pbw | 5 lbs./ton |
| 615 Rock Wool | 0.0100 pbw | 7 lbs./ton |
| Limestone flour | 0.5000 pbw | 1000 lbs./ton |

### EXAMPLE 8

| | | |
|---|---|---|
| Asphalt | 0.4580 pbw | 916 lbs./ton |
| G35 MinUGel ® | 0.0300 pbw | 60 lbs./ton |
| 230 Cellulose | 0.0120 pbw | 24 lbs./ton |
| Limestone flour | 0.5000 pbw | 1000 lbs./ton |

### EXAMPLE 9

| | | |
|---|---|---|
| Asphalt | 0.4600 pbw | 920 lbs./ton |
| G35 MinUGel ® | 0.0300 pbw | 60 lbs./ton |
| SS Polypropylene | 0.0100 pbw | 20 lbs./ton |
| Limestone flour | 0.5000 pbw | 1000 lbs./ton |

### EXAMPLE 10

| | | |
|---|---|---|
| Asphalt | 0.4200 pbw | 840 lbs./ton |
| G35 MinUGel ® | 0.0300 pbw | 60 lbs./ton |
| 615 Rock Wool | 0.0500 pbw | 100 lbs./ton |
| Limestone flour | 0.5000 pbw | 1000 lbs./ton |

### EXAMPLE 11

| | | |
|---|---|---|
| Asphalt | 0.4725 pbw | 915 lbs./ton |
| G35 MinUGel ® | 0.0300 pbw | 60 lbs./ton |
| 230 Cellulose | 0.0100 pbw | 20 lbs./ton |
| SS Polypropylene | 0.0025 pbw | 5 lbs./ton |
| Limestone flour | 0.5000 pbw | 1000 lbs./ton |

### EXAMPLE 12

| | | |
|---|---|---|
| Asphalt | 0.4615 pbw | 923 lbs./ton |
| G35 MinUGel ® | 0.0300 pbw | 60 lbs./ton |
| 230 Cellulose | 0.0050 pbw | 10 lbs./ton |
| 615 Rock Wool | 0.0035 pbw | 7 lbs./ton |
| Limestone flour | 0.5000 pbw | 1000 lbs./ton |

### EXAMPLE 13

| | | |
|---|---|---|
| Asphalt | 0.4620 pbw | 924 lbs./ton |
| G35 MinUGel ® | 0.0300 pbw | 60 lbs./ton |
| SS Polypropylene | 0.0045 pbw | 9 lbs./ton |
| 615 Rock Wool | 0.0035 pbw | 7 lbs./ton |
| Limestone flour | 0.5000 pbw | 1000 lbs./ton |

### EXAMPLE 14

| | | |
|---|---|---|
| Asphalt | 0.4595 pbw | 919 lbs./ton |
| G35 MinUGel ® | 0.0300 pbw | 60 lbs./ton |
| 230 Cellulose | 0.0045 pbw | 9 lbs./ton |
| SS Polypropylene | 0.0025 pbw | 5 lbs./ton |
| 615 Rock Wool | 0.0035 pbw | 7 lbs./ton |
| Limestone flour | 0.5000 pbw | 1000 lbs./ton |

Each of the example compositions was blended in the laboratory by introducing approximately one half of the asphalt at about 250-310 degrees F. into a shearing mixer, with the gelling clay and any surfactant, and mixing to form an asphaltic gel; blending the asphaltic gel with thixotropic agents such as any cellulose fiber and mineral wool to achieve a substantially uniform dispersion; blending in a separate mixer the remainder of the asphalt flux at about 350-400 degrees F. with the limestone or other mineral flour; and then mixing the contents of the two mixers.

Preparing any of the example compositions by the methods described herein results in approximately 10,000 lbs. of superior mopping grade asphalt composition, having a viscosity suitable for application at about 200 degrees F. Each of the compositions provides advantages as described herein. It is noted, however, that variation of relative amounts of the various components of the compositions can produce compositions having various characterstics, some of which may offer particular advantages in particular applications.

Compositions according to the invention, and in particular the compositions described in the examples, may also comprise additional additives to achieve other or additional purposes. For example, fire retardant compounds such as aluminum tryhydrate, and compounds intended to improve the dangerous, unlawful and/or otherwise unpleasant odors and emissions associated with hot mopping grade asphalts, may be used. It is especially advantageous to add such additional additives after a gel has been achieved, as the less-viscous intermediate compositions will serve to disperse the additional additives and prevent them from settling out.

It is expected that a wide variety of other fillers and modifiers, though not part of the experiments that produced the compositions described in the examples, will also serve to provide greater bulk and sealing properties in the finished compositions. It has been found that many such fillers and modifiers may readily be added to the composition using known techniques, the original manufacturing process, or once the base asphalt composition has been prepared as described herein. For example, based on experience with other asphalt compositions, it is expected that rubber modifiers such as styrene-ethylene-butadeiene-styrene (SEBS) copolymer, styrene-butylene-styrene (SBS) copolymer, and atactic polypropylene (APP) may be employed, with the advantages and using methods described in my co-owned prior patents U.S. Pat. No. 5,973,037 and others.

It is also understood that other synthetic and/or organic fillers may be used in combination with or in place of the described flours, rock wool, and other fillers. For example, long experience in preparing other types of asphalt compositions indicates that sand, ground slate, perlite, mica, talk, Wallastonite, wool, cotton, hemp, and diatomaceous earth will serve satisfactorily, and may be incorporated into the asphalt composition using preparation methods described herein, and/or after completion of the asphalt base.

While the foregoing invention has been described in some detail for purposes of clarity and understanding, it will be appreciated by one skilled in the art, from a reading of the disclosure, that various changes in form and detail can be made without departing from the true scope of the invention as described in the appended claims. The detailed description of the example embodiments is intended to be illustrative, and not limiting.

1. A method of preparing a non-cutback mopping grade asphalt composition, the method comprising preparing a mixture consisting of:
about 1.00 to about 4.95 parts by weight asphalt;
about 0.005 to about 0.50 parts by weight clay gelling agent;
about 0.0065 to about 0.50 parts by weight surfactant;
zero to about 4.25 parts by weight of a flour comprising at least 80 per cent by weight of at least one of calcium carbonate and magnesium carbonate;
zero to about 0.50 parts by weight cellulose fiber;
zero to about 0.50 parts by weight polyolefin fibers; and
zero to about 1.50 parts by weight mineral wool in one or more shearing mixers at a temperature high enough to provide substantially uniform dispersion of each of the mixed ingredients in the completed composition.

2. The method of claim 1, wherein the temperature of the asphalt in the mixer is less than 450 degrees Fahrenheit.

3. The method of claim 1, wherein the temperature of the asphalt upon introduction to the mixer is about 300 degrees Fahrenheit.

4. The method of claim 1, wherein the clay comprises attapulgite clay.

5. The method of claim 1, wherein the surfactant comprises ether amine.

6. The method of claim 1, wherein the surfactant comprises acetate.

7. The method of claim 1, wherein the surfactant comprises isodecyloxypropylamine acetate.

8. The method of claim 1, wherein the amount of asphalt is about 2.10 to about 2.40 parts by weight.

9. The method of claim 1, wherein the amount of clay is about 0.025 to about 0.30 parts by weight, and the clay is attapulgite.

10. The method of claim 7, wherein the amount of surfactant is about 0.15 parts by weight.

11. The method of claim 1, wherein the amount of flour is about 2.00 to about 3.00 parts by weight.

12. The method of claim 1, wherein the amount of cellulose fiber is about 0.0045 to about 0.10 parts by weight.

13. The method of claim 1, wherein the amount of polyolefin fibers is about 0.0025 to about 0.10 parts by weight.

14. The method of claim 1, wherein the polyolefin fibers comprise polypropylene.

15. The method of claim 1, wherein the amount of mineral wool is about 0.0035 to about 0.50 parts by weight.

16. The method of claim 1, comprising packaging the completed composition in consumable sheet material.

17. The method of claim 16, wherein the consumable sheet material comprises a plastic having a melting point of about 250 degrees Fahrenheit or higher.

18. The method of claim 16, wherein the plastic comprises polypropylene.

19. The method of claim 1, comprising mixing the asphalt with aluminum trihydrate.

20. A mopping grade asphalt composition prepared according to the method of claim 1.

21. The composition of claim 20, further comprising aluminum trihydrate.

22. A non-cutback mopping grade asphalt composition consisting of:
about 1.00 to about 4.95 parts by weight asphalt;
about 0.005 to about 0.50 parts by weight attapulgite clay;
about 0.0065 to about 0.50 parts by weight ether amine surfactant;
zero to about 4.25 parts by weight of a flour comprising at least 80 per cent by weight of at least one of calcium carbonate and magnesium carbonate;
zero to about 0.50 parts by weight cellulose fiber;
zero to about 0.50 parts by weight of polyolefin fibers; and
zero to about 1.50 parts by weight mineral wool.

23. The composition of claim 22, further consisting of aluminum trihydrate.

24. A non-cutback mopping grade asphalt composition consisting of:
about 2.10 to about 2.40 parts by weight asphalt;
about 0.025 to about 0.30 parts by weight attapulgite clay;
zero to about 0.15 parts by weight ether amine surfactant;
about 2.00 to about 3.00 parts by weight of a flour comprising at least 80 per cent by weight of at least one of calcium carbonate and magnesium carbonate;
zero to about 0.10 parts by weight cellulose fiber;
zero to about 0.10 parts by weight polyolefin fibers; and
zero to about 0.50 parts by weight mineral wool.

25. (canceled)

26. (canceled)

27. A method of preparing a non-cutback mopping grade asphalt composition, the method comprising preparing a mixture consisting of:
about 0.42 to about 0.48 parts by weight asphalt;
about 0.005 to about 0.06 parts by weight attapulgite clay;
zero to about 0.03 parts by weight ether amine surfactant;
about 0.4 parts to about 0.6 parts by weight of a flour comprising at least 80 per cent by weight of at least one of calcium carbonate and magnesium carbonate;
zero to about 0.02 parts by weight cellulose fiber;
zero to about 0.02 parts by weight polyolefin fibers; and
zero to about 0.1 parts by weight mineral wool in one or more shearing mixers at a temperature high enough to provide substantially uniform dispersion of each of the mixed ingredients in the completed composition.

28. The method of claim 27, wherein the amount of surfactant is about 0.0065 parts by weight.

29. The method of claim 27, wherein the temperature of the asphalt in the mixer is less than 450 degrees Fahrenheit.

30. The method of claim 27, wherein the temperature of the asphalt upon introduction to the mixer is about 300 degrees Fahrenheit.

31. The method of claim 27, wherein the clay comprises attapulgite clay.

32. The method of claim 27, wherein the surfactant comprises ether amine.

33. The method of claim 27, wherein the surfactant comprises acetate.

34. The method of claim 27, wherein the surfactant comprises isodecyloxypropylamine acetate.

35. The method of claim 27, wherein the amount of flour is about 0.5 parts by weight.

36. The method of claim 27, wherein the amount of clay is about 0.01 to about 0.03 parts by weight, and the clay is attapulgite.

37. The method of claim 27, wherein the amount of cellulose fiber is about zero to about 0.012 parts by weight.

38. The method of claim 27, wherein the amount of polyolefin fibers is about zero to about 0.01 parts by weight.

39. The method of claim 27, wherein the polyolefin fibers comprise polypropylene.

40. The method of claim 27, wherein the amount of mineral wool is about zero to about 0.05 parts by weight.

41. The method of claim 27, comprising packaging the completed composition in consumable sheet material.

42. The method of claim 41, wherein the consumable sheet material comprises a plastic having a melting point of about 250 degrees Fahrenheit or higher.

43. The method of claim 41, wherein the plastic comprises polypropylene.

44. The method of claim 27, comprising mixing the asphalt with aluminum trihydrate.

45. A non-cutback mopping grade asphalt composition prepared according to the method of claim 27.

46. The composition of claim 45, further comprising aluminum trihydrate.

47. A non-cutback mopping grade asphalt composition consisting of:
about 0.42 to about 0.48 parts by weight asphalt;
about 0.005 to about 0.06 parts by weight attapulgite clay;
zero to about 0.03 parts by weight ether amine surfactant;
about 0.4 parts to about 0.6 parts by weight of a flour comprising at least 80 per cent by weight of at least one of calcium carbonate and magnesium carbonate;
zero to about 0.02 parts by weight cellulose fiber;
zero to about 0.02 parts by weight polyolefin fibers; and
zero to about 0.1 parts by weight mineral wool.
